(19) United States
(12) Patent Application Publication
(10) Pub. No.: US 2015/0083803 A1
(43) Pub. Date: Mar. 26, 2015

(54) Systems and Methods for Individualized Customer Retail Services Using RFID Wristbands

(71) Applicants: Derek Herron, Lubbock, TX (US); Oscar Castillo, Lubbock, TX (US); Rob Lewis, Simpsonville, SC (US)

(72) Inventors: Derek Herron, Lubbock, TX (US); Oscar Castillo, Lubbock, TX (US); Rob Lewis, Simpsonville, SC (US)

(21) Appl. No.: 14/034,395

(22) Filed: Sep. 23, 2013

(51) Int. Cl. G06Q 30/02

(52) U.S. Cl. CPC G06Q 30/0207
USPC 235/380

(57) ABSTRACT

An RFID bracelet, wristband or other ticketing medium having an embedded RFID chip, is provided by an issuing organization such as a sports franchise and is utilized by a customer, such as a season ticket holder, for example. The bracelet tracks the customer's consumer behavior and provides incentives to use the bracelet, such as individualized targeted discounts on merchandise and concessions at an event. Customer information gathered is in real time and can be useful in marketing and promoting efforts in the current season. This allows the issuing organization to promote/market to a specific game or to a specific season ticket holder. Middleware mediates transactions between the RFID chip and the venue or a vendor, as well as other transactions.

### CROSS-REFERENCE TO RELATED APPLICATIONS

This application is a continuation-in-part of related co-pending provisional application Ser. No. 61/704,861; filed Sep. 24, 2012, by the same inventors and of the same title, the disclosure of which is incorporated herein by reference.

### TECHNICAL FIELD

This disclosure relates generally to systems and methods for individualized customer retail services using RFID wristbands and more particularly to middleware for RFID retail systems.

### BACKGROUND

RFID bracelets are known for paperless ticketed entry to events. The present disclosure describes a system and method that expands the usefulness of RFID bracelet systems by tracking user consumer behavior and allowing individualized event promotions and concessions or merchandise discounts, for example.

### SUMMARY

An RFID bracelet, wristband or other ticketing medium having an embedded RFID chip, issued by an issuing organization such as a sport franchise or festival promoter tracks season ticket holder behavior and provides incentives to use the bracelet, such as individualized targeted discounts on merchandise and concessions at an event. User information gathered is in real time and can be useful in marketing and promoting efforts in the current season. This allows the issuing organization to promote/market to a specific game or to a specific season ticket holder. Alternative embodiments are contemplated in which the RFID wristband also provides paperless (ticketless) entry to an event.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a schematic method flow diagram of a season ticket RFID wristband system process of the present disclosure.

FIG. 2 is a schematic method flow diagram of a RFID wristband system Point of Sales interaction process of the present disclosure.

FIG. 3 is a schematic system diagram of an individualized customer retail services system of the present disclosure.

FIG. 4 is a schematic system diagram of a season ticket RFID wristband system of the present disclosure.

### DETAILED DESCRIPTION

The system of the present disclosure is described herein below using the exemplary embodiment of sports season tickets, and in particular merchandise and concessions purchases at a sporting event venue, but the exemplary embodiment is not intended to limit the scope of the disclosure. It will be evident to those skilled in the art that the systems and methods can be adapted for use in a wide range of retail contexts. Alternative embodiments are contemplated in which the RFID wristband also provides paperless (ticketless) entry to an event. For the purposes of this disclosure RFID or RFID means Radio Frequency Identification and RFID tag means an object having an RFID chip. Although much of the exemplary embodiment refers to an RFID wristband or bracelet, it will be understood that any ticketing medium that has the capability to incorporate an RFID chip is suitable for the methods and systems of the present disclosure.

The present invention provides middleware for using RFID wristband event ticketing for individualized customer retail services at the event. Middleware is computer software that provides services to software applications beyond those available from the operating system. Middleware makes it easier for software developers to perform communication and input/output, so they can focus on the specific purpose of their application. The term is most commonly used for software that enables communication and management of data in distributed applications. In this more specific sense middleware can be described as “the dash in ‘client-server’” (or the ‘-to-’ in peer-to-peer for that matter).

ObjectWeb defines middleware as: “The software layer that lies between the operating system and applications on each side of a distributed computing system in a network.” Services that can be regarded as middleware include enterprise application integration, data integration, message oriented middleware (MOM), object request brokers (ORBs), and the enterprise service bus (ESB).

In a system of the present disclosure, season tickets subscribers for a sports franchise are provided, in addition to season tickets, a wrist band of the type that is familiar to festival goers and which is commonly used to promote awareness of various charities.

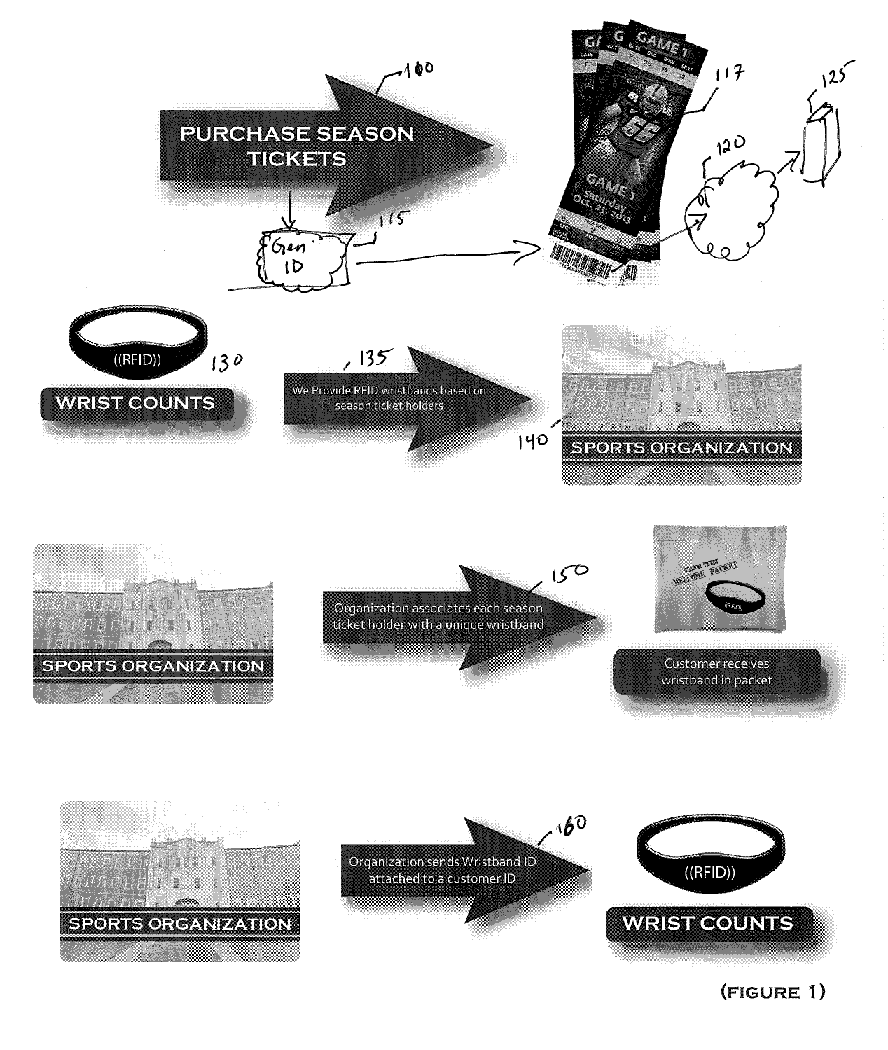

The wristband has an embedded RFID tag. FIG. 1 is a schematic method flow diagram of a season ticket RFID wristband system process of the present disclosure. As illustrated in FIG. 1, a method of using the present system includes without limitation the following steps:

Season Ticket is purchased by a User.

Unique User ID is generated and uploaded through the software to one or more servers via a network.

RFID Bracelets are obtained from a manufacturer and sent to the issuing Sports Organization.

Sports Organization scans bracelet to activate the RFID to the Unique User ID.

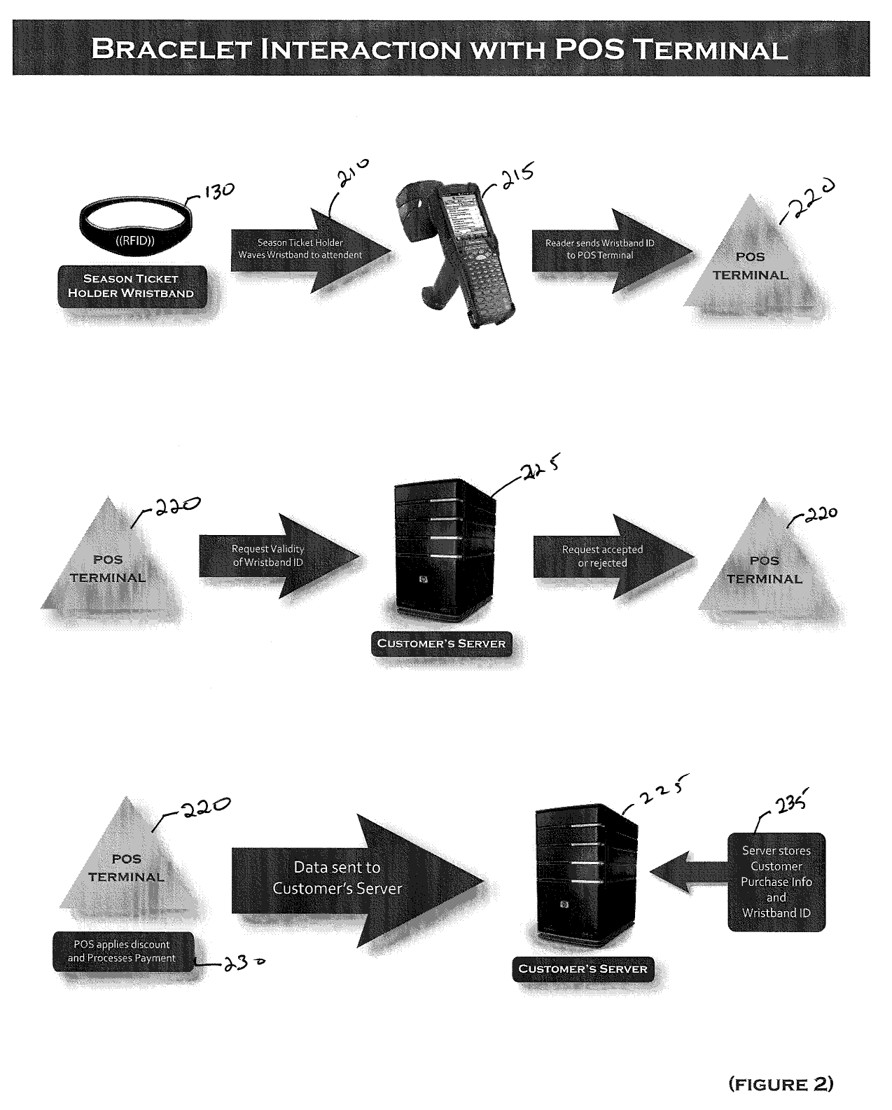

FIG. 2 is a schematic method flow diagram of a RFID wristband system Point of Sales (POS) interaction process of the present disclosure. A POS method includes without limitation the following steps: User waves RFID bracelet at wireless card reader at point of Sales (POS) terminals to apply discounts via the present middleware that mediates between the wristband and the POS terminal.

Purchase behavior collected and uploaded using the present middleware via a network to a server for each transaction involving a discount.

Purchase behavior compiled and provided to sports organization and/or concessionaire using the present middleware.

Individual promotions implemented by applying promotions to unique user IDs with the present middleware mediating between the promoting entity and the customer.

RFID bracelet discounts arranged with local retailers that are partnered with Donor Discounts.

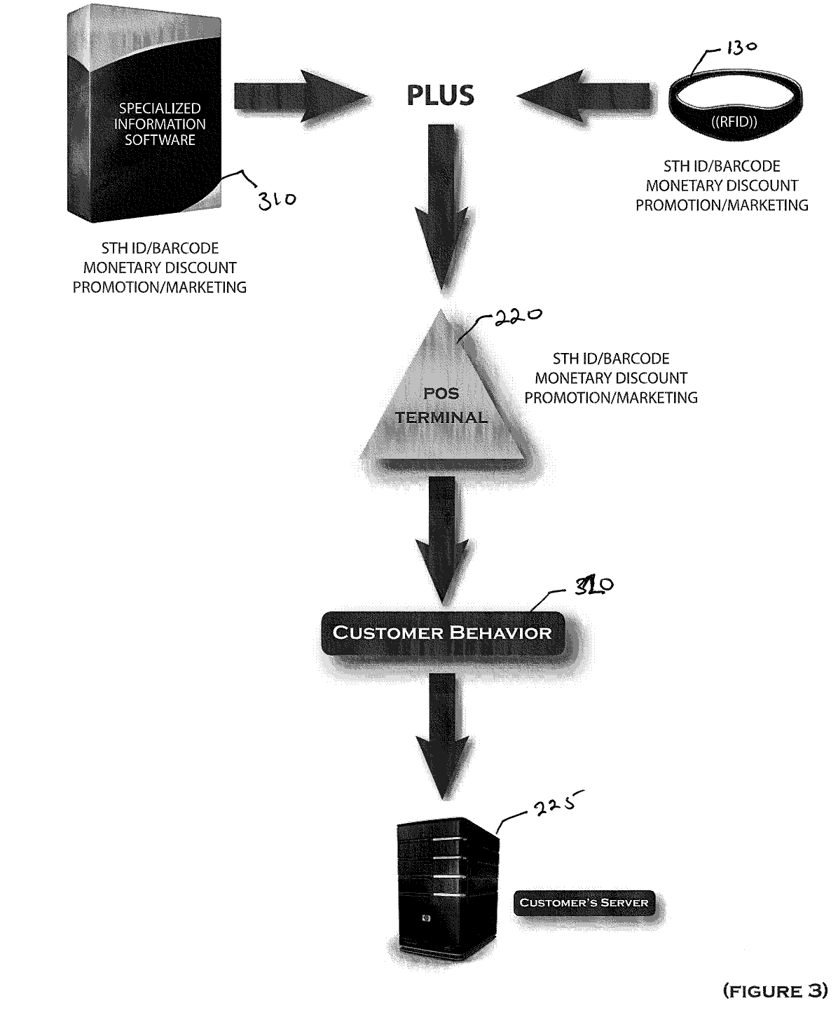

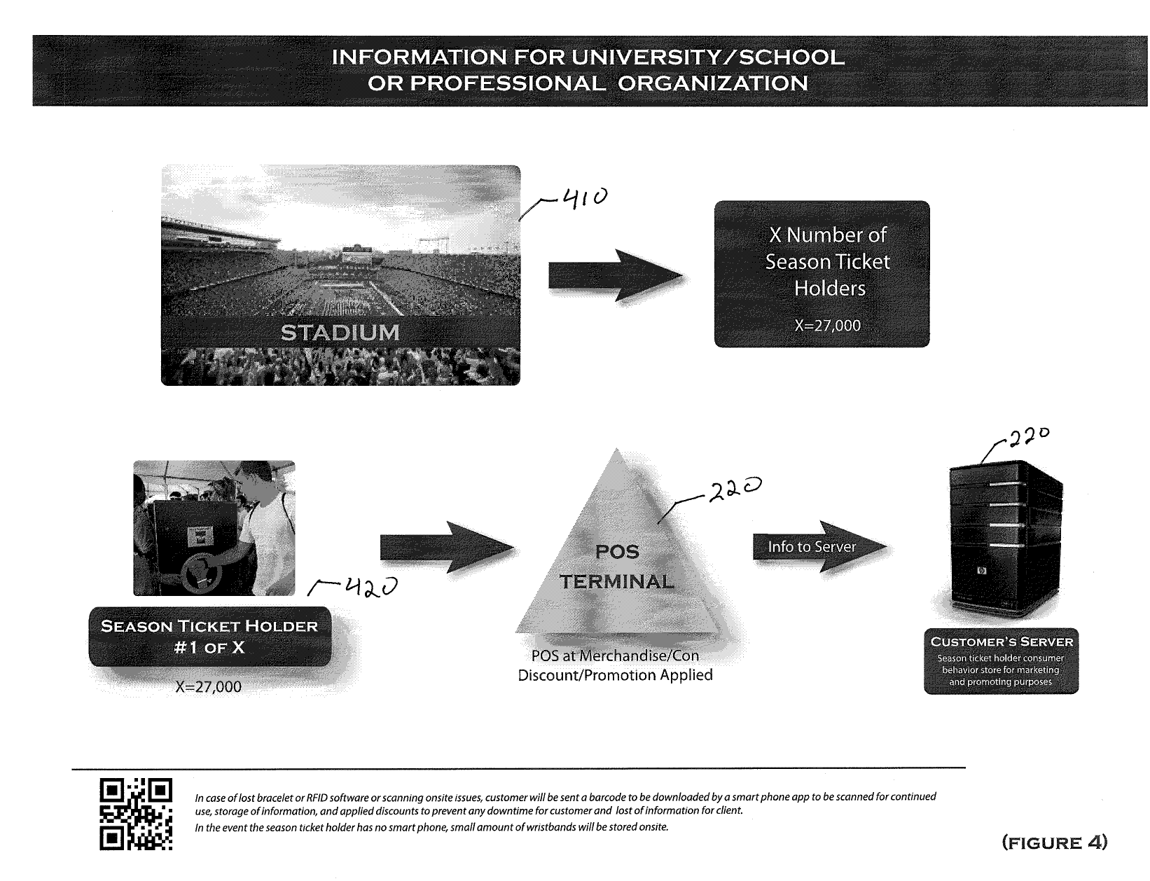

FIGS. 3 and 4 are discussed together. FIG. 3 is a schematic system diagram of an individualized customer retail services system and FIG. 4 is a schematic system diagram of a season ticket RFID wristband system, of the present disclosure.

The middleware software 310 provides for tiered discount plans for donor levels or priority points. ($500=10%, $1000=15%, etc.). The software works in conjunction with ticket 130, the venue 410, and POS 220 software systems.

Software provides customization capabilities dependent upon promotional needs of organization and reflecting the customer 420 behavior 320 to target promotions to susceptible customers.

In the case of a lost RFID ticket or in the event of RFID scanner failure, the present method provides that a barcode or Quick Read (QR) code be sent to the customer in a format that can be downloaded with a smartphone application (“app”) to be scanned for continued use, storage of information and applied discounts to prevent system downtime and loss of customer information. In the event a customer does not have a smartphone, a limited number of wristbands are available at the venue, which can be configured and activated for the customer.

The motivation of the season ticket embodiment is to give an incentive to be a season ticket holder by granting a discount bracelet for season ticket holders. This allows for an increase in season ticket sales. In alternative embodiments of the present system, purchase of the RFID wristband is not limited to season ticket holders, but is available to the general public or general admission patrons of the event.

The bracelet has the ability to track season ticket holder behavior and by giving an incentive to use the bracelet with the discount, the information gathered is in real time and can be useful in marketing and promoting efforts in the current season. This allows the issuing organization to promote/market to a specific game or to a specific season ticket holder (out of thousands).

This is advantageous in that most marketing/promoting is based on a previous year's information and, when large groups are concerned, all marketing/promoting efforts are in the form of mass marketing. The present system enables marketing/promoting to an individual ticket holder among thousands with an offer tailored to that individual based on their purchasing behavior.

The information obtained from the bracelet also helps keep inventory accurate and efficient and prevents the over purchasing of merchandise or concession items.

Advantages of the present methods and systems include without limitation:

1.0 University/School or Professional Organization current Season Ticket Holders (STH) Benefits
1.1 Increased Season Ticket Holders (STH).
1.2 Increased Merchandise Sales.
1.3 Increased Concession Sales.
1.4 Fan Appreciation/Satisfaction.
1.5 Branding and School Spirit.

2.0 Merchandise Benefits
2.1 Marketing/Promotional Efficiency. Ability to specify specific game or specific Season Ticket holder (STH).
2.2 Create initial visit to purchase merchandise.
2.3 Create potential for additional visits for merchandise purchases.
2.4 Inventory Efficiency.

3.0 Concession Benefits
3.1 Marketing/Promotional Efficiency. Ability to specify specific game or specific Season Ticket holder (STH).
3.2 Create initial visit to purchase concessions.
3.3 Create potential for additional visits for concession purchases.
3.4 Inventory Efficiency
3.5 Better compete with tailgaters.

Unique Components and Integration of Technology

4.0 Components
4.1 Specialized Information Software Consisting of Sorting/Saving of information of Discount/Promotions linked to the RFID.
4.2 RFID Chip with Unique Season Ticket Holder (STH) id number that can be linked to their season ticket barcode number
   For example: STH #1 of X STH's
4.3 Bracelets that house RFID chip personalized/customized to university/school or professional organization to display, for example, the school logo or team colors.
4.4 POS terminals with software at concession and merchandise sites.
4.5 Server that stores all information

5.0 Integration
Regular game attendee witnesses/hears about Season Ticket Holder (STH) discounts.
Regular game attendee wishes to receive discounts and becomes STH.
More information becomes available to make marketing promotion decisions.
More revenue is available with the addition of STH's for marketing/promotion decisions.

In addition to the foregoing embodiments, the present disclosure provides programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

An RFID system uses tags, or labels attached to the objects to be identified. Two-way radio transmitter-receivers called interrogators or readers send a signal to the tag and read its response. The readers generally transmit their observations to a computer system running RFID software or RFID middleware.

The tag's information is stored electronically in a non-volatile memory. The RFID tag includes a small RF transmitter and receiver. An RFID reader transmits an encoded radio signal to interrogate the tag. The tag receives the message and responds with its identification information. This may be only a unique tag serial number, or may be product-related information such as a stock number, lot or batch number, production date, or other specific information.

RFID tags can be either passive, active or battery assisted passive. An active tag has an on-board battery and periodically transmits its ID signal. A battery assisted passive (BAP) has a small battery on board and is activated when in the presence of a RFID reader. A passive tag is cheaper and smaller because it has no battery. Instead, the tag uses the radio energy transmitted by the reader as its energy source. The interrogator must be close for RF field to be strong enough to transfer sufficient power to the tag. Since tags have individual serial numbers, the RFID system design can discriminate several tags that might be within the range of the RFID reader and read them simultaneously.

Tags may either be read-only, having a factory-assigned serial number that is used as a key into a database, or may be read/write, where object-specific data can be written into the tag by the system user. Field programmable tags may be write-once, read-multiple; “blank” tags may be written with an electronic product code by the user.

RFID tags contain at least two parts: an integrated circuit for storing and processing information, modulating and demodulating a radio frequency (RF) signal, collecting DC power from the incident reader signal, and other specialized functions; and an antenna for receiving and transmitting the signal.

Fixed readers are set up to create a specific interrogation zone which can be tightly controlled. This allows a highly defined reading area for when tags go in and out of the interrogation zone. Mobile readers may be hand-held or mounted on carts or vehicles.

RFID frequency bands

| | | | | | | Approximate |
|---|---|---|---|---|---|---|
| | | | | | | tag cost |
| | | | | | | in volume |
| Band | Regulations | Range | | Data speed | Remarks | (2006) US $ |
| 120-150 kHz (LF) | Unregulated | 10 | cm | Low | Animal identification, | $1 US |
| | | | | | factory data collection | |
| 13.56 MHz (HF) | ISM band | 1 | m | Low to | Smart cards | $0.50 |
| | worldwide | | | moderate | | |
| 433 MHz (UHF) | Short Range | 1-100 | m | Moderate | Defence applications, | $5 |
| | Devices | | | | with active tags | |
| 868-870 MHz | ISM band | 1-2 | m | Moderate to | EAN, various | $0.15 (passive tags) |
| (Europe) | | | | high | standards | |
| 902-928 MHz | | | | | | |
| (North America) | | | | | | |
| UHF | | | | | | |
| 2450-5800 MHz | ISM band | 1-2 | m | High | 802.11 WLAN, | $25 (active tags) |
| (microwave) | | | | | Bluetooth standards | |

| | | | | | |
|---|---|---|---|---|---|
| 3.1-10 GHz | Ultra wide band | to 200M | High | requires semi-active or | $5 projected |
| (microwave) | | | | active tags | |

Signaling between the reader and the tag is done in several different incompatible ways, depending on the frequency band used by the tag. Tags operating on LF and HF frequencies are, in terms of radio wavelength, very close to the reader antenna, only a small percentage of a wavelength away. In this near field region, the tag is closely coupled electrically with the transmitter in the reader. The tag can modulate the field produced by the reader by changing the electrical loading the tag represents. By switching between lower and higher relative loads, the tag produces a change that the reader can detect. At UHF and higher frequencies, the tag is more than one radio wavelength away from the reader, requiring a different approach. The tag can backscattera signal. Active tags may contain functionally separated transmitters and receivers, and the tag need not respond on a frequency related to the reader's interrogation signal.

An Electronic Product Code (EPC) is one common type of data stored in a tag. When written into the tag by an RFID printer, the tag contains a 96-bit string of data. The first eight bits are a header which identifies the version of the protocol. The next 28 bits identify the organization that manages the data for this tag; the organization number is assigned by the EPCGlobal consortium. The next 24 bits are an object class, identifying the kind of product; the last 36 bits are a unique serial number for a particular tag. These last two fields are set by the organization that issued the tag. Rather like a URL, the total electronic product code number can be used as a key into a global database to uniquely identify a particular product.

Often more than one tag will respond to a tag reader, for example, many individual products with tags may be shipped in a common box or on a common pallet. Collision detection is important to allow reading of data. Two different types of protocols are used to “singulate” a particular tag, allowing its data to be read in the midst of many similar tags. In a Slotted Aloha system, the reader broadcasts an initialization command and a parameter that the tags individually use to pseudo-randomly delay their responses. When using an “adaptive binary tree” protocol, the reader sends an initialization symbol and then transmits one bit of ID data at a time; only tags with matching bits respond, and eventually only one tag matches the complete ID string.

Many modifications and other embodiments of the systems and methods described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. In an RFID ticketed event venue environment, wherein a ticket having an embedded RFID chip is provided to a customer by an event organizer and wherein vendors at the venue have RFID readers, a method for using an RFID event ticket for individualized customer retail services, the method comprising providing middleware to mediate transactions between the RFID ticket and the RFID reader whereby a vendor offers an individualized retail service to a customer and a customer accepts the service.

2. The method of claim 1, wherein the ticket comprises a wristband having an embedded RFID chip.

3. The method of claim 1, wherein the ticket comprises a season ticket.

4. The method of claim 1, further comprising providing middleware to mediate the provision of customer purchase behavior to the event organizer.

5. The method of claim 1, further comprising providing middleware to mediate the provision of customer purchase behavior to the vendor.

6. The method of claim 1, further comprising providing middleware to communicate a promotion from a vendor to a customer via the customer's RFID ticket.
